(19) United States
(12) Patent Application Publication
(10) Pub. No.: US 2008/0028832 A1
(43) Pub. Date: Feb. 7, 2008

(54) Best mode usage

(76) Inventors: George Dominic Sullivan, Evanston, IL (US); Daniel J. Sullivan, Livingston, MT (US)

Correspondence Address: VEDDER PRICE KAUFMAN & KAMMHOLZ, 222 N. LASALLE STREET, CHICAGO, IL, 60601, US

(21) Appl. No.: 11/708,089

(22) Filed: Feb. 20, 2007

Related U.S. Application Data
(63) Continuation of application No. 10/742,293, filed on Dec. 19, 2003.
(60) Provisional application No. 60/774,657, filed on Feb. 21, 2006.

(51) Int. Cl. G01N 7/00

(52) U.S. Cl. 73/31.07

(57) ABSTRACT

An apparatus for the collection of airborne microorganisms and gaseous effluvia is disclosed. The apparatus includes an air intake mechanism capable of drawing an air sample and an air intake chamber operatively coupled to the air intake mechanism so that the air sample passes therethrough. A reservoir containing a liquid is provided disposed relative to the air intake chamber such that the air sample passes through the reservoir and is percolated through the liquid so that airborne microorganisms or gaseous effluvia within the air sample becomes suspended in the liquid. An access port or clean wall portion or window walls of the air intake chamber or liquid reservoir for allowing the exterior or interior emission of an ultraviolet or radio or other frequency wavelength into the suspension liquid containing the microorganisms or gaseous effluvias so that there is emitted by them a so-called “ramen” response, scattered single or multiple wavelengths from the microorganisms or gaseous effluvia which may be multiplexed and transmitted to, captured or recognized by, and recorded electronically in spectrometers and computer instruments exterior to the intake chamber for testing. An exhaust chamber is also connected to the reservoir such that the air sample, upon passing through the liquid, passes through the liquid passes through the exhaust chamber and a sampling port is provided adjacent to the reservoir such that a sample of the liquid can be extracted therefrom.

### REFERENCE TO RELATED APPLICATION

The present application is a continuation of U.S. patent application Ser. No. 10/742,293, filed on Dec. 19, 2003, and entitled PORTABLE DISPOSABLE AIRBORNE PATHOGEN COLLECTION DEVICE AND SYSTEM, which application is now pending. The present patent application also claims priority from and the benefit of U.S. Provisional Patent Application No. 60/774,657, filed Feb. 21, 2006, and entitled MICRO-DETECT, which prior application is hereby incorporated herein by reference.

### BACKGROUND

The recent publication in Newsweek Magazine (Feb. 15, 2007) of a “four minute” thumbnail size DNA detection platform chip (with “potential to revolutionize medical diagnostics”) nevertheless illustrates the time-loss detection difference between it and the MDT Raman spectroscopy when it employs DWDM detection. The requisite elapsed time between the two methodologies greatly favors the MDT economy of timeliness.

The DNA chip developed by the Thermal Gradient Co. device (Pittsford, N.Y.) would require a compendium or series of individual time-consuming steps to obtain a suitable tested sample. They would include:

1. Sample separation from the source surface or liquid or gaseous capture substance

2. Sample preparation or condensation

3. Transport elapsed time to the test lab site

4. Insertion into the DNA chip by trained personnel

5. The DNA amplification time of an estimated several minutes

6. The preparation of the written test results

7. And the necessary diagnostic reading and conclusions of trained personnel.

The above essential and required steps of the DNA chip suffer a near fatal time lag when compared with the near immediate and automatic computerized spectra result of Raman spectroscopy, when applied to MDT captured organisms and which requires little or no trained interpretation, since the resulting automatic matching computerized spectra is verified automatically by a U.S. DHS maintained computer library or bank of each identified individualized spectra. Moreover, it appears that the DNA chip might require multiple chips for the detection of multiple pathogens in a single sample while the MDT capturing liquid is able to contain multiple pathogens each of which would emit or give off its own Raman scatter wavelengths and each of which can be transferred by DWDM simultaneously under its own wavelength which may be independently detected by its own spectra in a single Raman spectroscopy DWDM computerized system.

Additionally, the MDT is highly portable and lightweight (3-5 lbs.) for outdoor in-situ detection with immediate transferability to distant centrally or on-site located spectrometers and computers, and by wireless transfer or routing devices provided by Cisco Systems (San Jose, Calif.).

The current specter of a worldwide pandemic of Avian flu, and other naturally occurring airborne pathogens and gaseous affluvia now seeming to hover over mankind and has resulted in the near feverish demand for rapid, economical, and portable on-site pathogen detection equipment. This equipment must not only provide accurate detection in seconds, but, also be small and light enough to be quickly replaceable on-site by back-pack carried copies and cheap enough to be disposable after a single contaminated on-site assay as required by US federal health regulations. And lastly, the replacement must be readily available on-site for the secondary “confirmation” assays required before the issuance of public alarms and ready immediately for tracking of the usual drifting pathogenic cloud or plume, life threatening to the local populace.

Compounding this international lethal dilemma is the sudden appearance on the world scene of the present capability of bioterrorists to cause the explosion of a relatively small and/or portable amount of deadly gaseous affluvia or pathogens in a cloud of infectious microorganisms or gases upon a defenseless populace; both of which have excited near-universal fears of Armageddon. The United States Government through its Department of Homeland Security (DHS) has responded to this threat by sponsoring financial incentives for the development of a low cost Bio-Aerosol Detector System (LBADS-BAA 05-08.)

### SUMMARY OF THE INVENTION

Pursuant to 35 USCA 101 it is claimed that the claims set forth in this application for patent is and are new and useful improvements on the patent claims in its parent application specified above; and that all and each of such claims for reference purposes are incorporated herein, and made a part hereof, as fully as if each such claim had been set forth verbatim herein. These improvements lie principally in the critically important decrease of elapsed time of detection, the economies of price by virtue of fewer components such as crystals, and reagents and the lack of need for provisioning and inventorying of the same.

The portability and ease and utility of time and materials in tracking of the resulting airborne plume components; many if not all of these improvements made possible or improved by the discovery and increased implementation of Raman spectroscopy applied directly inside the MDTs, without the need to withdraw liquid samples, signal and surface enhancement and dense wavelength division multiplexing (DWDM), developed by major research by such U.S. companies as Cisco Systems and Lucent Technologies in recent years.

The best mode contemplated by the inventors for the use of the invention is that of a double assay in two separate Micro-Detect (MDT) vessels which it is believed would have the shortest elapsed identification time, and which not only confirms a positive separate or first assay of a given bio-terror pathogen attack or naturally occurring infestation dispersion but also the second companion device could disclose and track the direction and path of the pathogenic cloud or plume caused by a bio-terrorist WMD release. First usage and secondary confirmation assays should be conducted in a non-contaminated vessel or apparatus, namely, separate or multiple MDT's so as to lessen or avoid the possibility of the national pandemonium which might well attend the unconfirmed public dissemination of possibly false positive assay results which in its wake might have the effect to interrupt or shut down national commercial, transportation and even partial governmental activities of the nation itself.

Therefore, using this method as a primary and confirmatory secondary set of assays (even run contemporaneously) its double rapid on-site positive assay of the same pathogen increases to a very large degree the verity and the identifying method of the first positive assay of U.S. DHS-CDC (or naturally occurring pathogens) listings of highly infectious level of airborne pathogens or noxious effluvia. Therefore, in a highly infectious pathogen release into the atmosphere the confirmatory but more time consuming diagnostic system of choice would be the PCR method of identification of the DNA of the pathogen at an established laboratory, insomuch as DNA detection is considered by many authorities to be the most accurate. But it should be followed, immediately after reporting results to emergency control authorities, by successive portable on-site and downstream MDT plume samplings. Therefore, the brevity of the elapsed time to the first confirmation assay is of the essence of such operations, in order to protect the lives of first responders and the civilian populace, alike. Subsequent assays would be directed or orchestrated by the emergency control authority.

If, however, the biological pathogen attack to be assayed is of a sudden and surprise nature, and the airborne pathogens are even suspected to be of lethal nature, it is imperative to use the most rapid assay appraisal or identification method available which is believed to be the Micro-Detect (MDT) via Raman spectroscopy DWDM system methodology not only for initial detection and confirmation in whole or in part, but also to track the inevitable poisonous plume or infectious cloud moving away from the point of first explosion infestation or dissemination. However, the inventors would also conduct immediate companion MDT multiple tests in which a lesser number of nano-crystals coated with different reagents or radio labeled or Raman probes corresponding harmonically to one or more of the 15 or 20 most dangerous pathogens and noxious effluvia as rated by the U.S. DHS-CDC would be employed since the identity of the pathogen would be presumptively known by virtue of the first assay. They would be placed in several portable MDT vessels and in which, after, double or more nano crystal linkages, the different multiple colorations illuminated in the crystal can be again excited by ultra violet or laser gun or other excitation instrument attached to, or held against the wall of the MDT vessel. Its immediate visible (and/or auditory report through use of automatic ultra sound detection equipment) or spectrometer, positive results can be immediately again communicated to the on-site first responders and exposed civilians as well as to the Emergency Control Center. The rationale for this procedure is that saving civilian and first responders and hospital healthcare workers from lethal contamination is, and should be, the first imperative demand rather than to identify pathogens in a time-consuming remote off-site test procedure. The later laboratory procedures, of course, can immediately follow the visual on-site identification, employing liquid sample splits drawn from the same MDT vessel ports and rushed to a designated laboratory.

### BRIEF DESCRIPTION OF THE DRAWINGS

The invention will be better understood with reference to the following drawings wherein:

FIG. 1 illustrates a side view of a portable disposable airborne pathogen collection device, in accordance with one embodiment of the present invention;

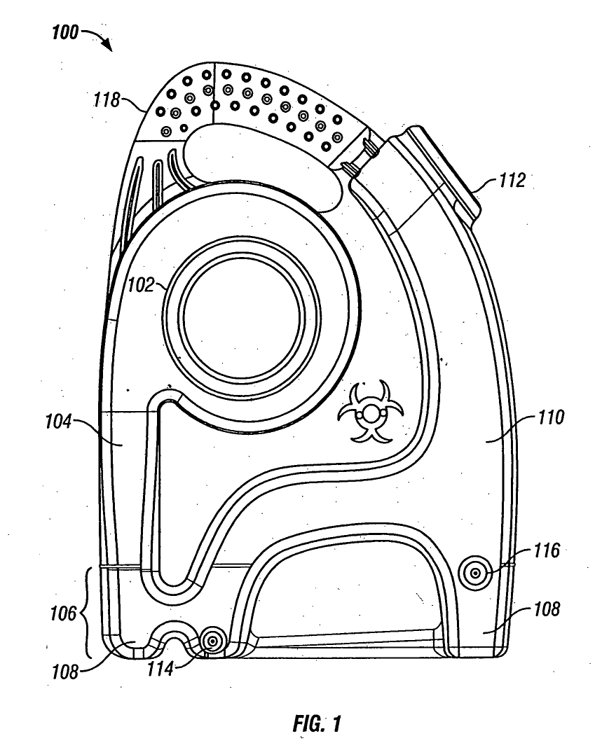

FIG. 2 illustrates a prospective view of the airborne pathogen collection device;

FIG. 3 illustrates a front view of the airborne pathogen collection device, in accordance with one embodiment of the present invention;

### DETAILED DESCRIPTION OF PREFERRED EMBODIMENTS

An apparatus for the simultaneous collection of airborne microorganisms and gaseous substances for detection by Raman Spectroscopy, excitation of dyes or of nano crystals, in one embodiment approximately 18″ to 24″ high and 3″ to 4″ in width, and weighing approximately 3-4 lbs. includes an air intake mechanism 102, which is capable of drawing in an air sample. In one embodiment, the air intake mechanism is a rotatable fan, which may be battery operated or powered by any other means such that the fan 102 rotates and draws the air sample therein at a rate of 15 to 25 CFM. The apparatus 100 further includes an air intake chamber 104 disposed between the air intake mechanism 102 and a reservoir 106 that contains a liquid means 108.

In one embodiment, the apparatus 100 is made of a composite formed hard translucent plastic material forming the cavities that define the air intake chamber 104 and the reservoir 106 containing the liquid means 108. Moreover, the liquid means 108 may be any available liquid capable of having an air sample percolated there through and supporting the suspension of one or more previously airborne pathogens or gaseous substances, such as distilled water, a liquid disinfectant, or any other suitable liquid capable of such suspension, and microspheres containing reagent coatings and enclosing various dyes, or similarly, nano crystals so coated.

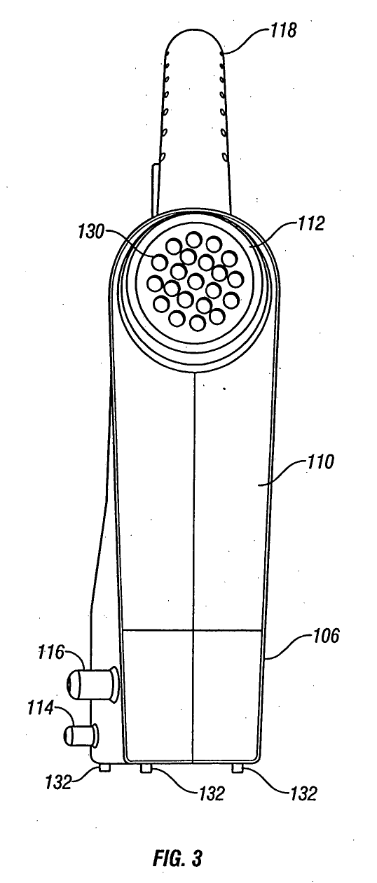

The apparatus 100 further includes an exhaust chamber 110 disposed above the reservoir 106 accessible through the liquid means 108 within the reservoir 106. Therefore, an air sample drawn in through the air intake 102 directed down through the air intake chamber 104, and percolated through the liquid means 108 may be exhausted through an exhaust 112 via the exhaust chamber 110. Furthermore, the exhaust chamber 110 and the exhaust 112 may be defined chambers based on the molded casing of the apparatus 100. Furthermore, the exhaust 112, may contain a perforated cover or filter as illustrated and discussed further below with respect to FIG. 3.

In one embodiment, the apparatus 100 contains outer frame indentation in which to fit a laser or ultra-violet or other ultra sound device to project its beams into contact with the aforesaid microorganisms, microspheres, or nanocrystals and further includes a sampling port 114 adjacent to the reservoir 106 such that a sample of microspheres and liquid means 108 may be extracted there through using extraction means such as a syringe. In one embodiment, the sampling port 114 is a hard plastic extension having a watertight seal with an opening for inserting a sample extraction device, such as a syringe, therethrough for the extraction of the beads or nanocrystals and/or liquid means 108. In one embodiment, the sampling port 114 is a resealable nipple allowing for the removal. of the liquid extraction device and the resealing of the liquid-tightness of the reservoir.

The apparatus 100 further includes liquid fill port 116 and a handle 118. The handle 118 is disposed, in one embodiment, on a posterior position for the ease of portability of the device and the liquid fill port 116 allows for the insertion of the liquid means 108 into the reservoir 106.

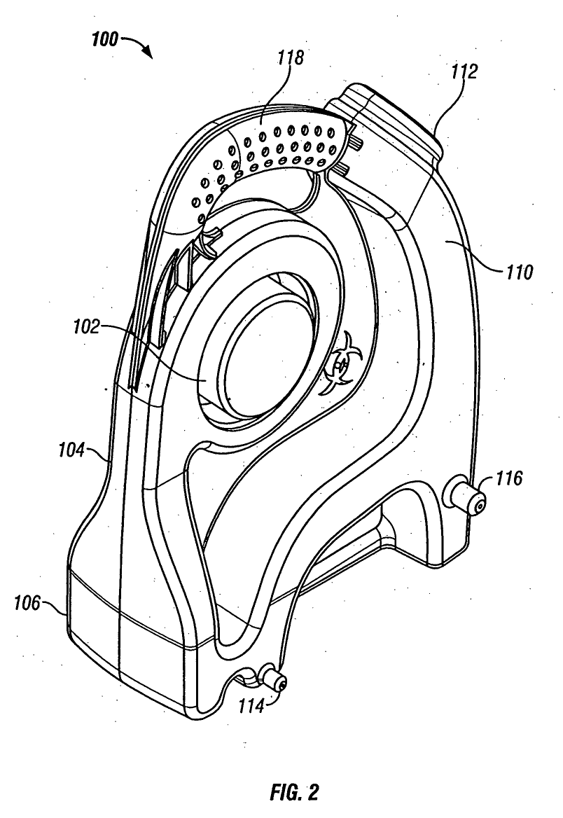

FIG. 2 illustrates a perspective view of the airborne collection device 100 better illustrating the perspective alignment of the various elements, including the reservoir 106, the liquid fill port 116, the sampling port 114, the air intake chamber 104 and the exhaust chamber 110. Further included in the apparatus 100, not visible in FIG. 2, are a plurality of base footing members disposed on the underside of the apparatus 100 for stabilizing the collection device 100 in an upright position. As better illustrated in FIG. 2, the sampling port 114 and the fill port 116 outwardly extend from the apparatus 100 for stabilizing the collection device 100 in an upright position. As better illustrated in FIG. 2, the sampling port 114 and the fill port 116 outwardly extend from the apparatus 100, more specifically extending outward from the reservoir 106, wherein the reservoir 106 extends the full length of the apparatus 100 divided by a portion of the exhaust chamber 110. FIG. 2 also illustrates, in one embodiment, the orientation of the handle 118 relative to the intake mechanism 102 and the exhaust 112.

FIG. 3 illustrates a front view of the apparatus 100 with the exhaust 112 at the exterior of the exhaust chamber 110. In one embodiment, the exhaust 112 includes a perforated cover and/or filter 130 for allowing the air sample to pass out of the apparatus 100. Further illustrated is the orientation of the handle 118, the outward extensions of the sample port 114 and the filling element 116. Furthermore, the base footing members 132 provide for lateral stability when the device 100 is rested on a flat surface.

In the above embodiment with the device 100, a plurality of the device 100 may be utilized wherein the devices are extremely portable and may be readily disposed of upon usage. Although, in the second embodiment of the present invention, a single base unit may be provided having a plurality of the disposable collection reservoirs. Upon the testing of the first air sample and the extraction through the sampling port, a first disposable collection reservoir may be removed from the base and a second disposable collection reservoir, a duplicate of the disposable collection reservoir, may be positioned on the base.

In furtherance with the collection of a sample of the microspheres and liquid means, the sample may be tested using a laboratory. In one embodiment, based on the mobility of the collection device 100, a mobile laboratory may be utilized for immediate testing at an on-site location. For example, an Agilent Mobile Laboratory may be utilized to perform analytical measurement system within a mobile laboratory to detect and confirm the presence of chemical and biological agents. The mobile laboratory and the ADDS is available for purchase from General Electric Corporation and the said microspheres and laser devices, and other detecting devices, are also readily available in the United States.

Whether the testing is performed in a mobile laboratory or other testing device, using any available testing techniques, the liquid means sample is tested for the presence of airborne pathogens including microorganisms. For example, mass spectrometry may be utilized to perform spectromatic testing. In another embodiment, chromatography may be utilized to test the liquid sample. Regardless thereof, on the extraction of a liquid means sample, a liquid means sample may be tested using any commonly available or known testing system such as a “PCR” genetic detector, which allows for the verification or authentication of airborne pathogens or microorganism suspended within the liquid means.

It should be understood that there exists implementation of other variations and modifications of the invention and its various aspects, as may be readily apparent to those of ordinary skill in the art, and that the invention is not limited by the specific embodiments described herein. For example, the apparatus 100 may be composed of any readily available material allowing for the formation of the defined air passage chambers and liquid means holding reservoir, wherein the material allows for easy portability and disposability. It is therefore contemplated and covered by the present invention, any and all such modifications.

Further, for example, the crucial necessity of immediate verification of the precise gaseous or so-called genetic “fingerprint”, almost immediately following the first positive particulate or gaseous assay is here presented with a unique solution by the multiplicity of lightweight devices being delivered to a test site in a multiple numbers in the same transportation “pack” or carrying case. The momentary change in numbers and morphology of a pathogen or the dissipation of a gas within moments of a first sample can be essential to the determination of the proper defense or medical prescription to combat the threat to life posed in a given terrorist attack. The infinitesimally small concentration sub-micron size of a given pathogen and the rapid dissipation of the strength of a gaseous substance demand immediate confirmation retesting. The means must be immediately at hand together with exact duplicate liquids and microspheres in place and with battery or back-up power supply. Indeed, if the period of gestation of a known or unknown microorganism pathogen upon the human or animal species is very brief, the immediacy of verification and diagnosis may spell life or death to the victim of inhalation or skin absorption. The reproduction, therefore, of the immediate and exact measurement of the WMD agent presents a unique necessity for the multiple pack assembly of diagnostic equipment so exactly specialized to repeat and quickly confirm or deny the threat to life that it can be best described as essential.

What is claimed is:

1. An apparatus for the collection of at least one of an airborne microorganisms and gaseous effluvia, the apparatus comprising:
an air intake mechanism capable of drawing an air sample;
an air intake chamber operatively coupled to the air intake mechanism such that the air sample is passed therethrough;
a reservoir containing a liquid means, the reservoir disposed relative to the air intake chamber such that the air sample passes through the reservoir and is percolated through the liquid means such that airborne microorganisms or gaseous effluvia within the air sample becomes suspended in the liquid means,
an access port or clean wall portion or window walls of the air intake chamber or liquid reservoir for allowing the exterior or interior emission of an ultraviolet or other radio or other frequency wavelength into such suspension liquid containing such microorganisms or gaseous effluvia so that there is or are emitted by them a so-called “Raman” response “scatter” single or multiple wavelengths, from such microorganisms or gaseous effluvia, which Raman responses may be multiplexed and transmitted to and captured or recognized by and recorded electronically in spectrometers and computer instruments exterior to the intake chamber for testing;
an exhaust chamber operatively coupled to the reservoir such that the air sample, upon passing through the liquid means, passes through the exhaust chamber; and
a sampling port adjacent to the reservoir such that a sample of the liquid means may be extracted therefrom.

2. The apparatus of claim 1 wherein the air intake mechanism is a motor-powered fan.

3. The apparatus of claim 1 further comprising:
a carrying handle such that the apparatus is mobile.

4. The apparatus of claim 1 further comprising:
a liquid fill port adjacent to the reservoir such that the reservoir may be provided with the microorganism or gaseous substance suspension liquid through the liquid fill port.

5. The apparatus of claim 1 further comprising:
a plurality of stabilizing feet disposed on the bottom side of the apparatus.

6. The apparatus of claim 1 wherein the air intake chamber, the reservoir and the exhaust chamber are defined by a plastic casing, wherein the plastic casing is disposable.

7. The apparatus of claim 1 wherein the liquid means is at least one of the following: distilled water and liquid disinfectant:
wherein the plastic casing is positioned together in a carrying case with at least two duplicate tubes therewith.

8. The apparatus of claim 1 which is multiple packaged as portable for use in tracking the aerial movement of an airborne plume of pathogens or gaseous effluvia emitted by an airborne pathogen or gaseous effluvia explosion or hostile act.
